(19) United States
(12) Patent Application Publication
(10) Pub. No.: US 2015/0062061 A1
(43) Pub. Date: Mar. 5, 2015

(54) DRIVING METHOD OF TOUCH SYSTEM

(71) Applicant: Chunghwa Picture Tubes, Ltd., Taoyuan (TW)

(72) Inventors: Chao-Yong Hsu, Taoyuan County (TW); Hung-Hsiang Chen, Taoyuan County (TW); Shih-Hung Huang, Taoyuan County (TW)

(73) Assignee: Chunghwa Picture Tubes, Ltd., Taoyuan (TW)

(21) Appl. No.: 14/079,651

(22) Filed: Nov. 14, 2013

(30) Foreign Application Priority Data
Sep. 4, 2013 (TW) 102131864

(51) Int. Cl. G06F 3/044; G09G 3/36

(52) U.S. Cl. CPC G06F 3/044; G09G 3/3648
USPC 345/174; 345/87

(57) ABSTRACT

A driving method of a touch system includes a liquid crystal panel driving circuit driving each block of a plurality of blocks of a liquid crystal panel to display an image in turn according to a first control signal during a frame time; a touch sensing circuit capturing a current panel noise base line of a touch block of a touch panel non-corresponding to the block according to a second control signal during the block displaying the image; the touch sensing circuit updating a previous panel noise base line of the touch block during a previous frame time according to the current panel noise base line; the touch sensing circuit executing touch sensing on the touch block to generate touch raw data according to a third control signal; and the touch sensing circuit generating touch data according to the touch raw data and the current panel noise base line.

### BACKGROUND OF THE INVENTION

1. Field of the Invention

The present invention relates to a driving method of a touch system, and more particularly, to a driving method of a touch system that can dynamically update a panel noise base line to reduce interference of a liquid crystal panel and increase accuracy of touch data generated by a touch sensing circuit.

2. Description of the Prior Art

A capacitive touch panel usually generates noise due to an outer environment and a characteristic of a liquid crystal panel. For example, when liquid crystals of the liquid crystal panel rotate, a capacitance of the liquid crystal panel will vary according to rotation of the liquid crystals. The variation of the capacitance of the liquid crystal panel will affect touch signals of the capacitive touch panel. When a processor detects a touch signal, the processor utilizes a threshold to determine whether the touch signal is noise. That is, when the touch signal is larger than the threshold, the processor will determined that the touch signal is a real touch signal. However, sometimes determining results of the processor maybe wrong due to noise generated by the capacitive touch panel is too large.

If the processor utilizes a signal processing technique to filter the noise generated by the capacitive touch panel, accuracy of the determining results of the processor may be increased, but complexity of the processor is also increased. Further, if the processor utilizes blanking time of the liquid crystal panel (e.g., H-sync blanking time or V-sync blanking time of the liquid crystal panel) to perform touch detection, the complexity of the processor will not be increased, but a report rate of the touch signals will be limited to 60 Hz.

Therefore, none of the above mentioned techniques is a desired choice for a capacitive touch panel designer.

### SUMMARY OF THE INVENTION

According to an embodiment of the present invention, a driving method of a touch system is provided. The touch system includes a timing controller, a touch panel, a liquid crystal panel, a liquid crystal panel driving circuit, and a touch sensing circuit. The liquid crystal panel is divided into a plurality of blocks. The driving method includes: the timing controller generating a first control signal, a second control signal, and a third control signal; the liquid crystal panel driving circuit driving each block of the plurality of blocks of the liquid crystal panel to display an image in turn according to the first control signal during a frame time; the touch sensing circuit simultaneously capturing a current panel noise base line of a touch block of the touch panel non-corresponding to the block according to the second control signal during the block displaying the image; the touch sensing circuit updating a previous panel noise base line of the touch block during a previous frame time according to the current panel noise base line; the touch sensing circuit executing touch sensing on the touch block to generate corresponding touch raw data according to the third control signal; and the touch sensing circuit generating touch data corresponding to the touch block according to the touch raw data and the current panel noise base line.

According to another embodiment of the present invention, a driving method of a touch system is provided. The touch system includes a timing controller, a touch panel, a liquid crystal panel, a liquid crystal panel driving circuit, and a touch sensing circuit. The liquid crystal panel is divided into a plurality of blocks. The driving method includes: the timing controller generating a first control signal, a second control signal, and a third control signal; the liquid crystal panel driving circuit driving each block of the plurality of blocks of the liquid crystal panel to display an image in turn according to the first control signal during a frame time; the touch sensing circuit capturing a current panel noise base line corresponding to the touch panel according to the second control signal during a vertical blank time of the frame time; the touch sensing circuit updating a previous panel noise base line of the touch block during a previous frame time according to the current panel noise base line; the touch sensing circuit executing touch sensing on the touch block to generate corresponding touch raw data according to the third control signal; and the touch sensing circuit generating touch data corresponding to the touch block according to the touch raw data and the current panel noise base line.

The present invention provides a driving method of a touch system provided. The method utilizes the touch sensing circuit to capture a current panel noise base line corresponding to a touch block of the touch panel, or utilizes the touch sensing circuit capture a current panel noise base line corresponding to the whole touch panel. When the touch sensing circuit captures the current panel noise base line corresponding to the touch block of the touch panel, the touch sensing circuit generates touch data corresponding to the touch block according to touch raw data and the current panel noise base line corresponding to the touch block. When the touch sensing circuit captures the current panel noise base line corresponding to the whole touch panel, the touch sensing circuit generates touch data corresponding to the touch block according to touch raw data corresponding to the touch block and the current panel noise base line corresponding to the whole touch panel. Compared with the prior art, because the present invention is capable of dynamically updating the panel noise base line corresponding to the touch block and the panel noise base line corresponding to the whole touch panel, the present invention not only can reduce interference of the liquid crystal panel to increase accuracy of touch data generated by the touch sensing circuit, but can not also limit a report rate of touch signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a touch system.

FIG. 2 is a diagram illustrating a position relationship of a touch panel and a liquid crystal panel.

FIG. 3 is a diagram illustrating a liquid crystal panel having a plurality of blocks.

FIG. 4 is a flowchart illustrating a driving method of a touch system according to an embodiment of the present invention.

FIG. 5 is a diagram illustrating the display timing of a plurality of blocks of the liquid crystal panel and the timing of a touch sensing circuit capturing a current panel noise base line of the touch panel.

FIG. 6 is a diagram illustrating the relationship between a current panel noise base line, a previous panel noise base line, a threshold and a touch signal.

FIG. 7 is a flowchart illustrating a driving method of a touch system according to another embodiment of the present invention.

FIG. 8 is a diagram illustrating the display timing of a plurality of blocks of the liquid crystal panel and the timing of a touch sensing circuit capturing a current panel noise base line of the touch panel.

### DETAILED DESCRIPTION

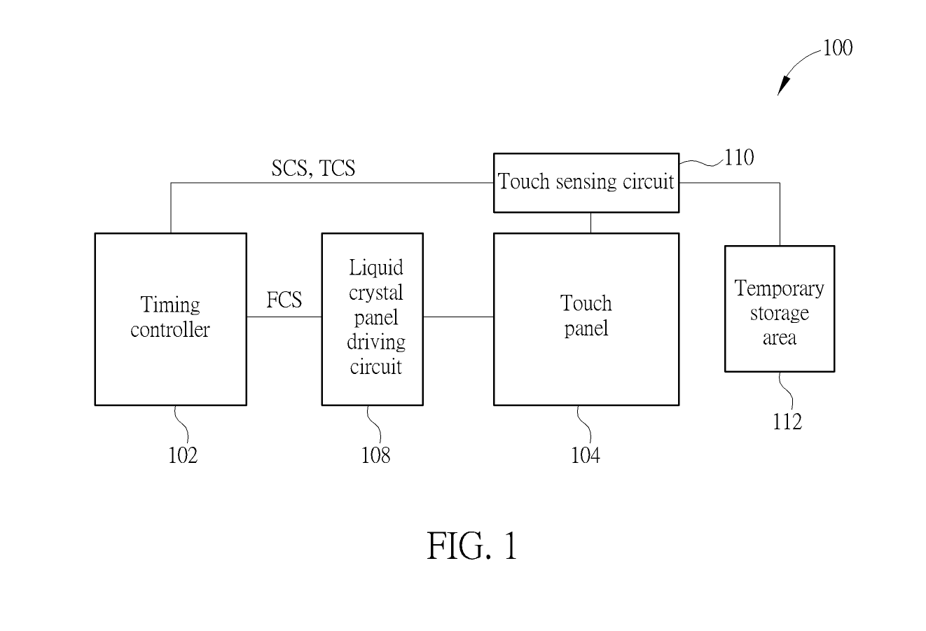

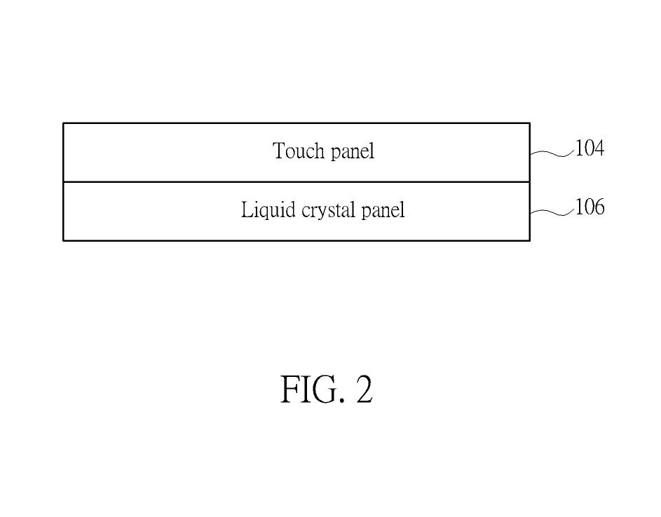

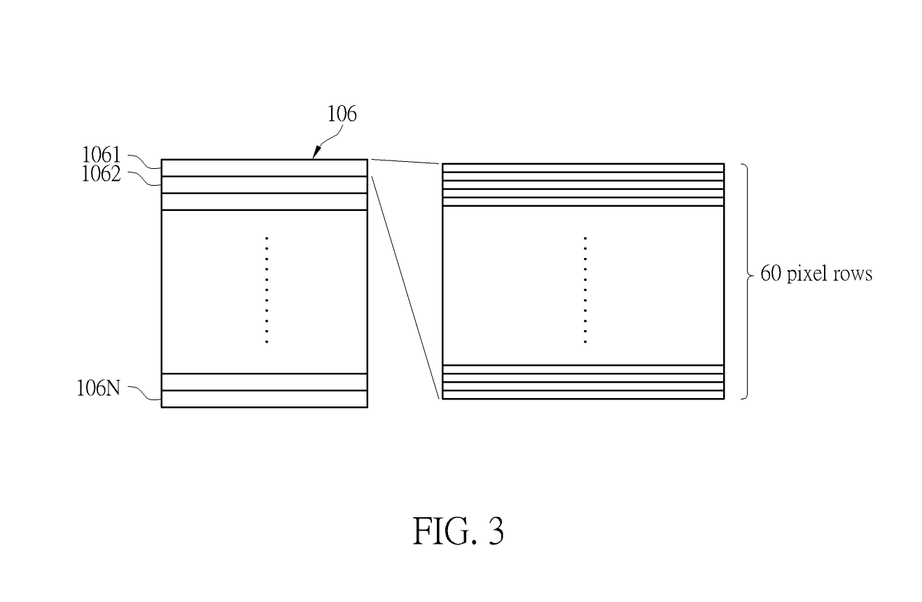

Please refer to FIG. 1, which is a diagram illustrating a touch system 100. As shown in FIG. 1, the touch system 100 includes a timing controller 102, a touch panel 104, and a liquid crystal panel 106 (not shown in FIG. 1), a liquid crystal panel driving circuit 108, and a touch sensing circuit 110. The touch panel 104 locates on the liquid crystal panel 106 (as shown in FIG. 2). The liquid crystal panel 106 has a plurality of blocks 1061-106N (as shown in FIG. 3), and N is a positive number. In general, a number of pixel rows of the liquid crystal panel 106 is larger than a number of touch sensing unit rows of the touch panel 104. Hence, width of a plurality of pixel rows of the liquid crystal panel 106 is equal to width of one touch unit row of the touch panel 104, and a number of the plurality of blocks 1062-106N of the liquid crystal panel 106 is equal to the number of the touch sensing unit rows of the touch panel 104. For example, as shown in FIG. 3, if a resolution of the liquid crystal panel 106 is 540*960, and width of 60 pixel rows is equal to width of one touch sensing unit row, the touch panel 104 will have 16 touch sensing unit rows. Since the touch panel has the 16 touch sensing unit rows, the liquid crystal panel 106 will have 16 blocks. However, the present invention is not limited to that width of 60 pixel rows being equal to width of one touch sensing unit row. Further, the touch panel 104 is a mutual-inductance capacitive touch panel in this embodiment. But, in another embodiment of the present invention, the touch panel 104 is a self-inductance capacitive touch panel.

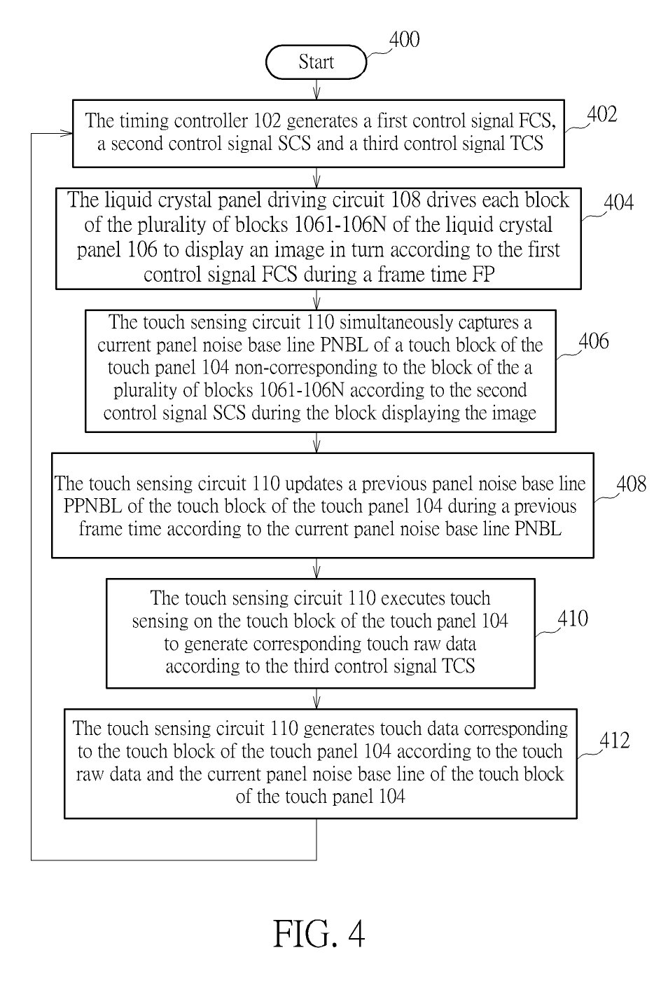

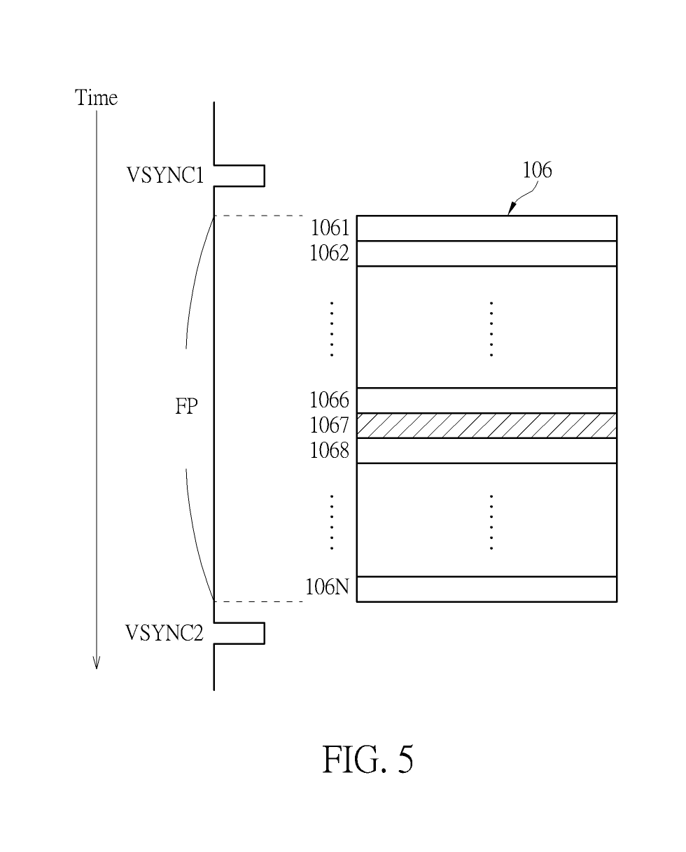

Please refer to FIG. 4 and FIG. 5. FIG. 4 is a flowchart illustrating a driving method of a touch system according to an embodiment of the present invention, and FIG. 5 is a diagram illustrating a display timing of the plurality of blocks 1061-106N of the liquid crystal panel 106 and a timing of the touch sensing circuit 110 capturing a current panel noise base line of the touch panel 104. The method in FIG. 4 is illustrated using the touch system 100 in FIG. 1. Detailed steps are as follows:

Step 400: Start.

Step 402: The timing controller 102 generates a first control signal FCS, a second control signal SCS and a third control signal TCS.

Step 404: The liquid crystal panel driving circuit 108 drives each block of the plurality of blocks 1061-106N of the liquid crystal panel 106 to display an image in turn according to the first control signal FCS during a frame time FP.

Step 406: The touch sensing circuit 110 simultaneously captures a current panel noise base line PNBL of a touch block of the touch panel 104 non-corresponding to the block of the a plurality of blocks 1061-106N according to the second control signal SCS during the block displaying the image.

Step 408: The touch sensing circuit 110 updates a previous panel noise base line PPNBL of the touch block of the touch panel 104 during a previous frame time according to the current panel noise base line PNBL;

Step 410: The touch sensing circuit 110 executes touch sensing on the touch block of the touch panel 104 to generate corresponding touch raw data according to the third control signal TCS.

Step 412: The touch sensing circuit 110 generates touch data corresponding to the touch block of the touch panel 104 according to the touch raw data and the current panel noise base line of the touch block of the touch panel 104. Then go to step 402.

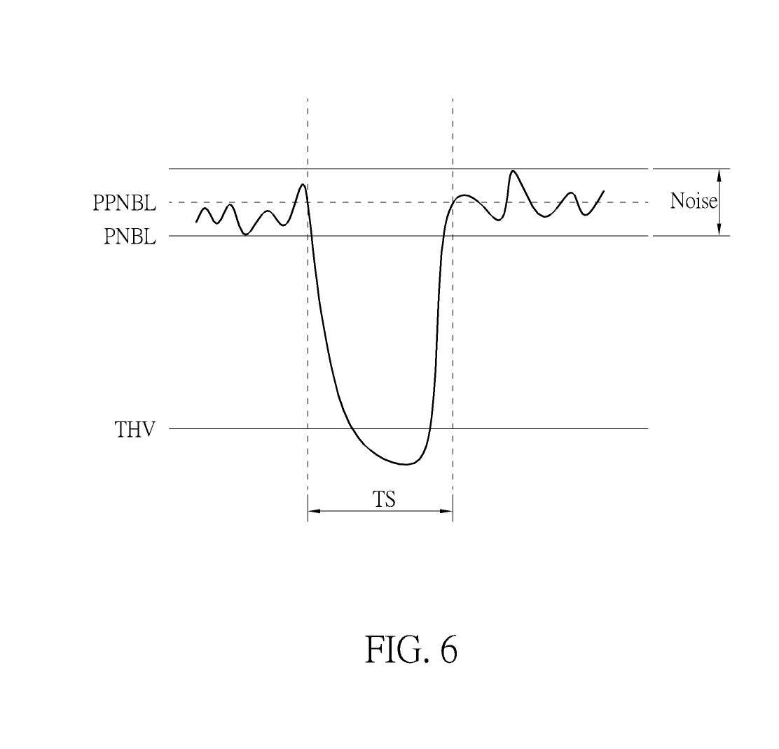

In step 404, the liquid crystal panel driving circuit 108 drives each block of the plurality of blocks 1061-106N of the liquid crystal panel 106 to display an image in turn according to the first control signal FCS from top to down, wherein the frame time FP is between two consecutive vertical synchronous signals VSYNC1 and VSYNC2 of the touch panel 106. Hence, as shown in FIG. 5, the liquid crystal panel driving circuit 108 is driving the block 1067 to display an image according to the first control signal FCS. That is, the liquid crystal panel driving circuit 108 has previously driven the blocks 1061-1066 to display corresponding images according to the first signal FCS. In step 406, the touch sensing circuit 110 captures a current panel noise base line PNBL of each touch block of the touch panel 104 in turn according to the second control signal SCS, wherein the touch sensing circuit 110 does not capture a current panel noise base line of a touch block corresponding to the block 1067 of the touch panel 104 according to the second control signal SCS. Hence, when the block 1067 display the image, the touch sensing circuit 110 can simultaneously capture a current panel noise base line PNBL (as shown in FIG. 6) of a touch block of the touch panel 104 non-corresponding to the block 1067, wherein the touch block of the touch panel 104 corresponds to a block of the blocks 1061-1066 or a block of the blocks 1068-106N. Since the touch sensing circuit 110 simultaneously captures the current panel noise base line PNBL of a touch block of the touch panel 104 non-corresponding to the block 1067, a display rate of the plurality of blocks 1061-106N of the liquid crystal panel 106 is equal to a rate of the touch sensing circuit 110 capturing current panel noise base lines of the plurality of touch blocks. Further, when the touch sensing circuit 110 prepares to capture a current panel noise base line PNBL of a touch block of the touch panel 104 according to the second control signal SCS and prepares to execute a touch sensing on the touch block of the touch panel 104 according to the third control signal TCS during the block 1067 displaying the image, the touch sensing circuit 110 first executes the touch sensing on the touch block of the touch panel 104 according to the third control signal TCS, and then captures the current panel noise base line PNBL of the touch block of the touch panel 104 according to the second control signal SCS. In step 408, the touch sensing circuit 110 updates the previous panel noise base line PPNBL of the touch block of the touch panel 104 during the previous frame time according to the current panel noise base line PNBL, wherein the previous panel noise base line PPNBL of the touch block of the touch panel 104 during the previous frame time is stored in a temporary storage area 112 of the touch system 100, and the current panel noise base line PNBL of the touch block of the touch panel 104 locates under the previous panel noise base line PPNBL of the touch block (as shown in FIG. 6). In step 410 and step 412, when the touch sensing circuit 110 executes touch sensing on the touch block of the touch panel 104 to generate corresponding touch raw data according to the third control signal TCS, the touch sensing circuit 110 can generate touch data corresponding to the touch block of the touch panel 104 according to the touch raw data and the current panel noise base line PNBL of the touch block of the touch panel 104.

As shown in FIG. 6, since the touch sensing circuit 110 updates the previous panel noise base line PPNBL of the touch block of the touch panel 104 during the previous frame time according to the current panel noise base line PNBL, most noise (locates above the current panel noise base line PNBL) is ignored by the touch sensing circuit 110. Hence, the touch sensing circuit 110 may determines that a touch signal TS is not noise according to the current panel noise base line PNBL and a threshold THV. Further, if the touch panel 104 is a self-inductance capacitive touch panel, the current panel noise base line PNBL of the touch block of the touch panel 104 locates above the previous panel noise base line PPNBL of the touch block during the previous frame.

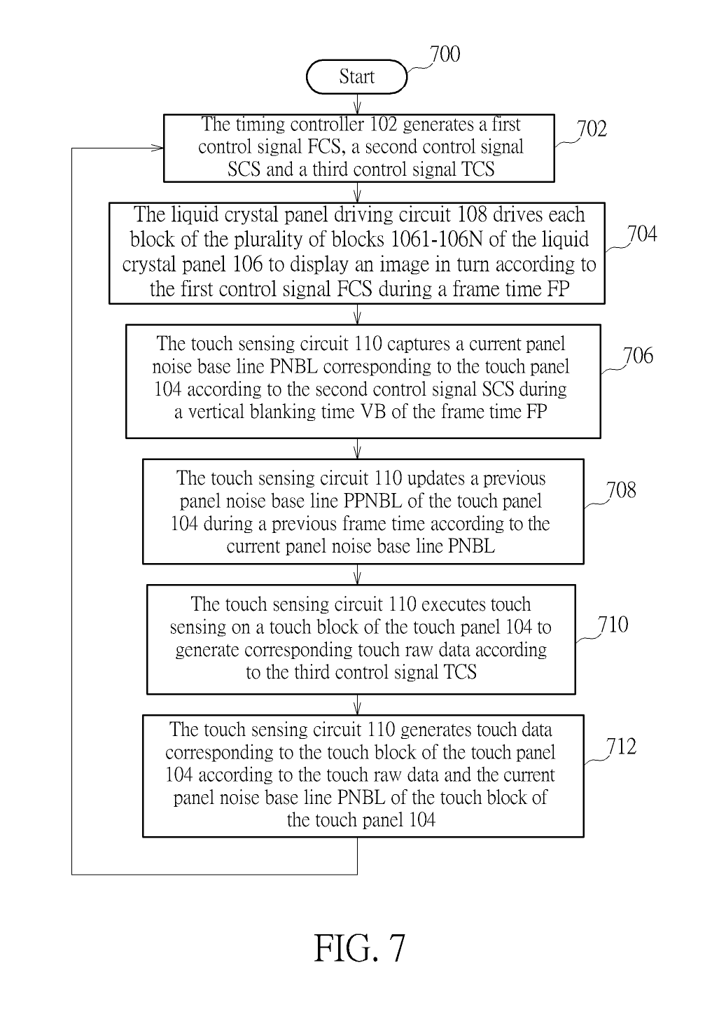

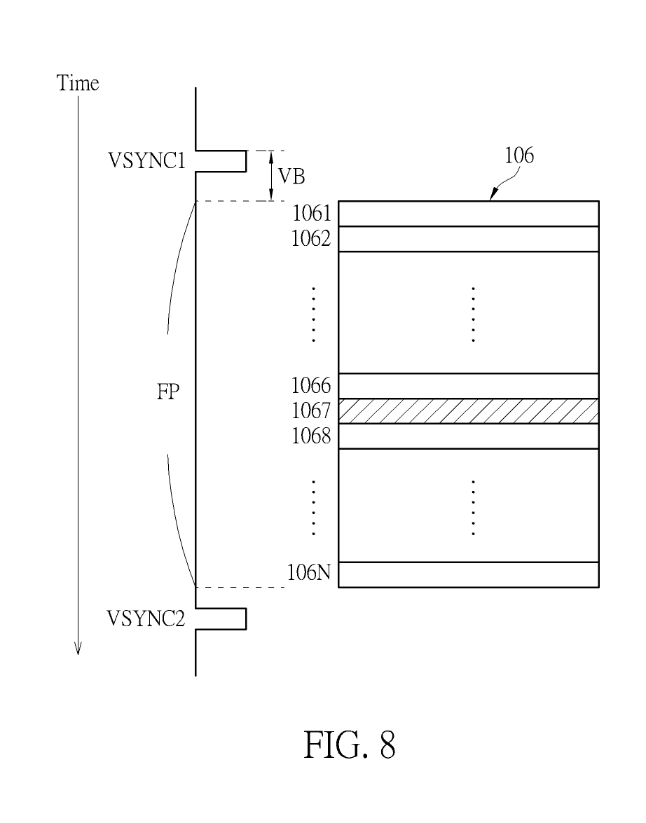

Please refer to FIG. 7 and FIG. 8. FIG. 7 is a flowchart illustrating a driving method of a touch system according to another embodiment of the present invention. FIG. 8 is a diagram illustrating a display timing of the plurality of blocks 1061-106N of the liquid crystal panel 106 and a timing of the touch sensing circuit 110 capturing a current panel noise base line of the touch panel 104. The method in FIG. 7 is illustrated using the touch system 100 in FIG. 1. Detailed steps are as follows:

Step 700: Start.

Step 702: The timing controller 102 generates a first control signal FCS, a second control signal SCS and a third control signal TCS.

Step 704: The liquid crystal panel driving circuit 108 drives each block of the plurality of blocks 1061-106N of the liquid crystal panel 106 to display an image in turn according to the first control signal FCS during a frame time FP.

Step 706: The touch sensing circuit 110 captures a current panel noise base line PNBL corresponding to the touch panel 104 according to the second control signal SCS during a vertical blanking time VB of the frame time FP.

Step 708: The touch sensing circuit 110 updates a previous panel noise base line PPNBL of the touch panel 104 during a previous frame time according to the current panel noise base line PNBL.

Step 710: The touch sensing circuit 110 executes touch sensing on a touch block of the touch panel 104 to generate corresponding touch raw data according to the third control signal TCS.

Step 712: The touch sensing circuit 110 generates touch data corresponding to the touch block of the touch panel 104 according to the touch raw data and the current panel noise base line PNBL of the touch block of the touch panel 104. Then go to step 702.

As shown in FIG. 8, a difference between the embodiment of FIG. 7 and the embodiment of FIG. 4 is that, in steps 706, the touch sensing circuit 110 captures the current panel noise base line PNBL corresponding to the touch panel 104 according to the second control signal SCS during the vertical blanking time VB of the frame time FP, and then in step 708, the touch sensing circuit 110 updates a previous panel noise base line PPNBL of the touch panel 104 during the previous frame time according to the current panel noise base line PNBL. Hence, in the embodiment of FIG. 7, the current panel noise base line PNBL corresponds to the whole touch panel 104 instead of corresponding to a block of the touch panel 104. Further, the rest operation theories of the embodiment of FIG. 7 are similar to those of the embodiment of FIG. 4, and are omitted for brevity.

In view of above, the driving method of a touch system provided by the present invention utilizes the touch sensing circuit to capture a current panel noise base line corresponding to a touch block of the touch panel, or utilizes the touch sensing circuit capture a current panel noise base line corresponding to the whole touch panel. When the touch sensing circuit captures the current panel noise base line corresponding to the touch block of the touch panel, the touch sensing circuit generates touch data corresponding to the touch block according to touch raw data and the current panel noise base line corresponding to the touch block. When the touch sensing circuit captures the current panel noise base line corresponding to the whole touch panel, the touch sensing circuit generates touch data corresponding to the touch block according to touch raw data corresponding to the touch block and the current panel noise base line corresponding to the whole touch panel. Compared with the prior art, because the present invention is capable of dynamically updating the panel noise base line corresponding to the touch block and the panel noise base line corresponding to the whole touch panel, the present invention not only can reduce interference of the liquid crystal panel to increase accuracy of touch data generated by the touch sensing circuit, but can not also limit a report rate of touch signals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method of a touch system, the touch system comprising a timing controller, a touch panel, a liquid crystal panel, a liquid crystal panel driving circuit, and a touch sensing circuit, wherein the liquid crystal panel is divided into a plurality of blocks, and the driving method comprising:
the timing controller generating a first control signal, a second control signal, and a third control signal;
the liquid crystal panel driving circuit driving each block of the plurality of blocks of the liquid crystal panel to display an image in turn according to the first control signal during a frame time;
the touch sensing circuit simultaneously capturing a current panel noise base line of a touch block of the touch panel non-corresponding to the block according to the second control signal during the block displaying the image;
the touch sensing circuit updating a previous panel noise base line of the touch block during a previous frame time according to the current panel noise base line;
the touch sensing circuit executing touch sensing on the touch block to generate corresponding touch raw data according to the third control signal; and
the touch sensing circuit generating touch data corresponding to the touch block according to the touch raw data and the current panel noise base line.

2. The driving method of claim 1, wherein when the touch sensing circuit prepares to capture the current panel noise base line of the touch block according to the second control signal and prepares to execute the touch sensing on the touch block according to the third control signal during the block displaying the image, the touch sensing circuit first executes the touch sensing on the touch block according to the third control signal, and then captures the current panel noise base line of the touch block according to the second control signal.

3. The driving method of claim 1, wherein the frame time is between two consecutive vertical synchronous signals of the touch panel.

4. The driving method of claim 1, wherein a number of the plurality of blocks is equal to a number of a plurality of touch sensing unit rows of the touch panel.

5. The driving method of claim 1, wherein the touch panel is a mutual-inductance capacitive touch panel.

6. The driving method of claim 1, wherein the touch panel is a self-inductance capacitive touch panel.

7. A driving method of a touch system, the touch system comprising a timing controller, a touch panel, a liquid crystal panel, a liquid crystal panel driving circuit, and a touch sensing circuit, wherein the liquid crystal panel is divided into a plurality of blocks, and the driving method comprising:
the timing controller generating a first control signal, a second control signal, and a third control signal;
the liquid crystal panel driving circuit driving each block of the plurality of blocks of the liquid crystal panel to display an image in turn according to the first control signal during a frame time;
the touch sensing circuit capturing a current panel noise base line corresponding to the touch panel according to the second control signal during a vertical blank time of the frame time;
the touch sensing circuit updating a previous panel noise base line of the touch block during a previous frame time according to the current panel noise base line;
the touch sensing circuit executing touch sensing on the touch block to generate corresponding touch raw data according to the third control signal; and
the touch sensing circuit generating touch data corresponding to the touch block according to the touch raw data and the current panel noise base line.

8. The driving method of claim 7, wherein the frame time is between two consecutive vertical synchronous signals of the touch panel.

9. The driving method of claim 7, wherein a number of the plurality of blocks is equal to a number of a plurality of touch sensing unit rows of the touch panel.

10. The driving method of claim 7, wherein the touch panel is a mutual-inductance capacitive touch panel.

11. The driving method of claim 7, wherein the touch panel is a self-inductance capacitive touch panel.
